(19) United States
(12) Patent Application Publication
(10) Pub. No.: US 2010/0151215 A1
(43) Pub. Date: Jun. 17, 2010

(54) METHOD OF MAKING AN EMBOSSED CARD AND AN EMBOSSED CARD MADE THEREFROM

(76) Inventor: Kuo-Ching LIU, Taipei (TW)

Correspondence Address: LADAS & PARRY LLP, 224 SOUTH MICHIGAN AVENUE, SUITE 1600, CHICAGO, IL, 60604, US

(21) Appl. No.: 12/427,793

(22) Filed: Apr. 22, 2009

(30) Foreign Application Priority Data
Dec. 15, 2008 (CN) 200820181414.9

(51) Int. Cl. B32B 5/18; B29C 59/02; C25D 5/56; B32B 38/06

(52) U.S. Cl. 428/201; 264/132; 205/114; 156/277

(57) ABSTRACT

A method of making an embossed card includes: (a) providing a stack which includes a substrate, a first polymeric layer formed on the substrate, a foam layer formed on the first polymeric layer, a non-woven fabric layer formed on the foam layer, and a second polymeric layer formed on the non-woven layer; (b) providing a printed pattern on the second polymeric layer; (c) providing a transparent film on the printed pattern so as to form a multilayer structure; and (d) embossing the multilayer structure so as to obtain the embossed card.

### CROSS-REFERENCE TO RELATED APPLICATION

This application claims priority of Chinese application No. 200820181414.9, filed on Dec. 15, 2008.

### BACKGROUND OF THE INVENTION

1. Field of the Invention

This invention relates to a method of making an embossed card, more particularly to a method of making an embossed card including a multilayer structure.

2. Description of the Related Art

Referring to FIG. 1, a conventional embossed card 1 is usually made from a metal sheet 11, such as a copper or aluminum sheet, which is formed with an embossed pattern 111 thereon through an embossing machine. Since the metal sheet 11 is not provided with any support structure at an inner side thereof, the embossed pattern 111 as formed thereon is unable to present sufficient three-dimensional effect. Moreover, the embossed pattern 111 is easily deformable when subjected to an external force, such as a compressive force exerted thereon as shown in FIG. 2. As a result, the conventional embossed card 1 has low collectible value and is not appealing to consumers.

### SUMMARY OF THE INVENTION

Therefore, an object of the present invention is to provide a method of making an embossed card that can overcome the aforesaid drawbacks associated with the prior art.

Another object of this invention is to provide a non-deformable embossed card.

According to one aspect of this invention, a method of making an embossed card comprises: (a) providing a stack which includes a substrate, a first polymeric layer formed on the substrate, a foam layer formed on the first polymeric layer, a non-woven fabric layer formed on the foam layer, and a second polymeric layer formed on the non-woven layer; (b) providing a printed pattern on the second polymeric layer; (c) providing a transparent film on the printed pattern so as to form a multilayer structure; and (d) embossing the multilayer structure so as to obtain the embossed card.

According to another aspect of this invention, an embossed card comprises an embossed multilayer structure including: a substrate; a first polymeric layer formed on the substrate; a foam layer formed on the first polymeric layer; a non-woven fabric layer formed on the foam layer; a second polymeric layer formed on the non-woven fabric layer; a printed pattern disposed on the second polymeric layer; and a transparent film covering the printed pattern.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a sectional view of a conventional embossed card;

FIG. 2 illustrates the conventional embossed card which is deformed by an external force applied thereto;

FIG. 3 is a flowchart illustrating the preferred embodiment of a method of making an embossed card according to this invention;

FIG. 4 is a sectional view of a multilayer structure formed in the preferred embodiment;

FIG. 5 is a sectional view of an embossed card formed from the multilayer structure according to the preferred embodiment;

FIG. 6 is a perspective view of the embossed card; and

FIG. 7 is a perspective view showing the embossed card provided with a sticker.

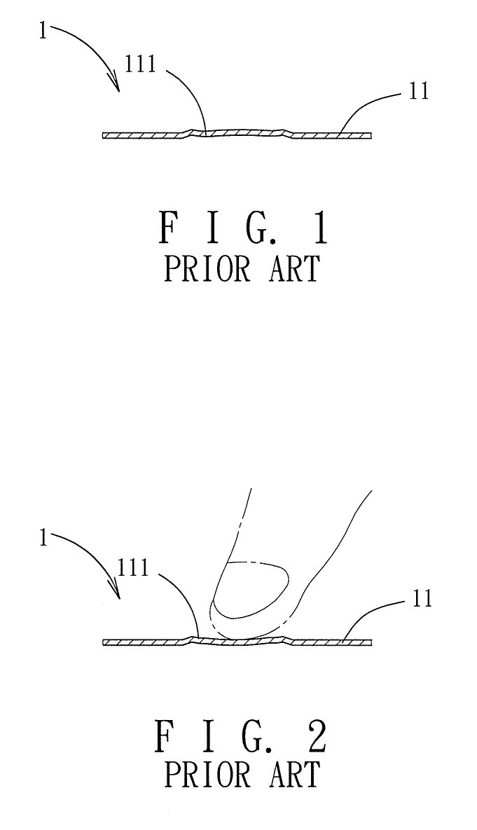

### DETAILED DESCRIPTION OF THE PREFERRED EMBODIMENTS

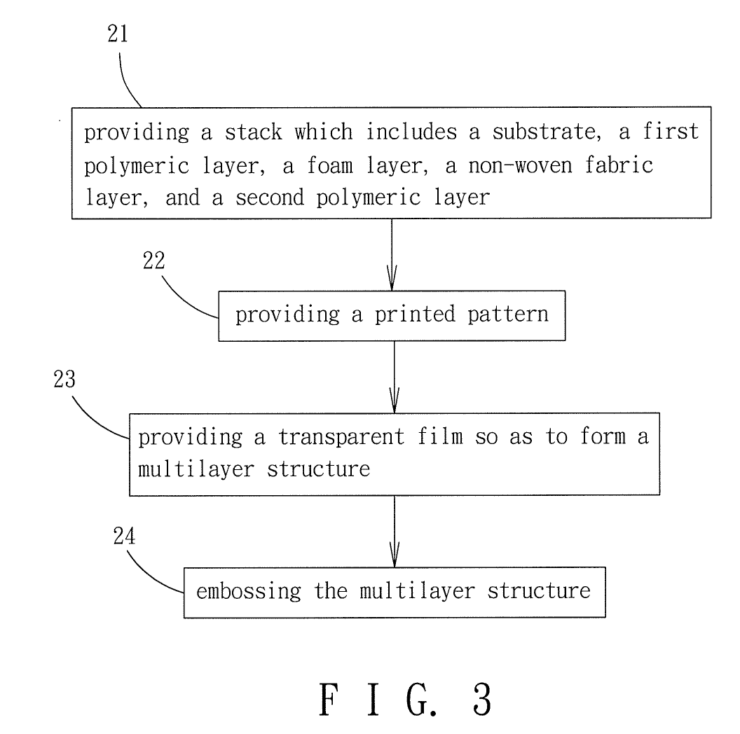

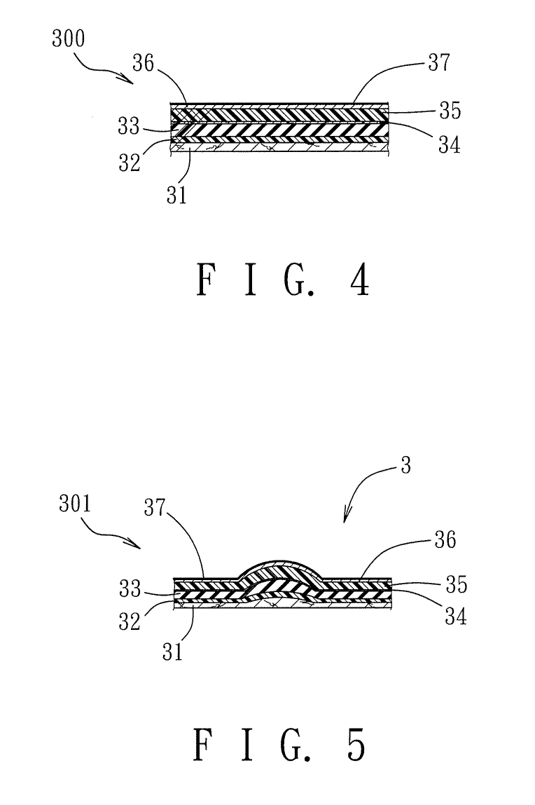

Referring to FIGS. 3 to 6, a method of making an embossed card 3 according to a preferred embodiment of the invention includes steps 21 to 24.

In step 21, a stack is formed by stacking a substrate 31 made of polystyrene, a first polymeric layer 32 that is formed on the substrate 31 and that is made of ethylene vinyl acetate copolymer, a foam layer 33 adhered to the first polymeric layer 32, a non-woven fabric layer 34 adhered to the foam layer 33, and a second polymeric layer 35 that is adhered to the non-woven fabric layer 34 and that is made of ethylene vinyl acetate copolymer.

Ethylene vinyl acetate copolymer (EVA) is solid under room temperature, and becomes melted liquid when heated to a high temperature and rapidly solidifies when cooled. The melted ethylene vinyl acetate copolymer may be applied directly to the substrate 31, followed by cooling the melted ethylene vinyl acetate copolymer so as to form the first polymeric layer 32 on the substrate 31. Alternatively, a solid ethylene vinyl acetate copolymer can be bonded adhesively to the substrate 31 so as to form the first polymeric layer 32 on the substrate 31. In this embodiment, the first polymeric layer 32 is formed by adhering the solid ethylene vinyl acetate copolymer to the substrate 31.

Preferably, the foam layer 33 is made of a material selected from the group consisting of ethylene vinyl acetate copolymer, polyvinyl chloride, polyethylene terephthalate, thermoplastic polyurethane, and combinations thereof.

In this embodiment, the first and second polymeric layers 32, 35 have a thickness of 0.4 mm and 0.1 mm, respectively.

In step 22, a printed pattern 36 is formed on the second polymeric layer 35 using ink.

In step 23, after the ink has dried, a transparent film 37 is provided on the printed pattern 36 by adhesive bonding or coating so as to form a multilayer structure 300.

In this preferred embodiment, the transparent film 37 is made of biaxially oriented polypropylene.

According to another preferred embodiment, electroplating is conducted to attach an electroplated film (not shown) to the second polymeric layer 35 prior to step 23. Subsequently, the printed pattern 36 is provided on the electroplated film, and thereafter the transparent film 37 is formed according to step 23.

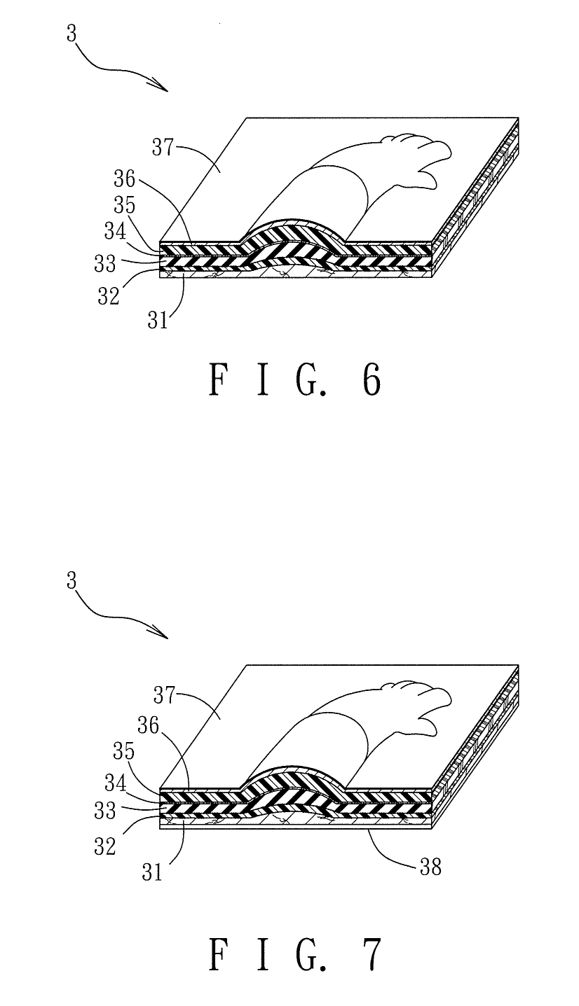

In step 24, referring to FIGS. 5 and 6, the multilayer structure 300 is disposed using a high frequency embossing machine, and a downward force is applied to the multilayer structure 300 such that the multilayer structure 300 is embossed with a predetermined pattern so as to obtain the embossed card 3.

Therefore, the embossed card 3 made by the method according to the present invention includes: an embossed multilayer structure 301 including the substrate 31; the first polymeric layer 32 formed on the substrate 31; the foam layer 33 formed on the first polymeric layer 32; the non-woven fabric layer 34 formed on the foam layer 33; the second polymeric layer 35 formed on the non-woven fabric layer 34; the printed pattern 36 disposed on the second polymeric layer 35; and the transparent film 37 covering the printed pattern 36. The function of the foam layer 33 is to provide thickness for the embossed card 3. The non-woven fabric layer 34 is used for improving surface evenness on the foam layer 33.

The thickness of the embossed multilayer structure 301 primarily depends on the thickness of the foam layer 33. In this embodiment, the foam layer 33 has a thickness of about 2 mm.

Moreover, since the foam layer 33 has good formability and is sandwiched between the first and second polymeric layers 32, 35, the embossed card 3 has a good three-dimensional effect when embossed, and the embossed pattern formed thereon has high stability and good resistance to deformation due to external pressure.

In case electroplating is conducted, the embossed multilayer structure 301 will further include the electroplated film (not shown) attached to the second polymeric layer 35, the printed pattern 36 is provided on the electroplated film, and the transparent film 37 is disposed over the printed pattern 36.

Referring to FIG. 7, in order to diversify application of the embossed card 3, a tape or sticker, or a magnetic sheet 38 is attached to the substrate 31 opposite to the first polymeric layer 32 so that the embossed card 3 can be attached to a desired object.

The method of making the embossed card 3 according to the invention is simple, and the embossed card 3 made by the method has a non-deformable embossed pattern which is durable against an external force, thereby increasing interest in collecting the embossed card 3.

With the invention thus explained, it is apparent that various modifications and variations can be made without departing from the spirit of the present invention. It is therefore intended that the invention be limited only as recited in the appended claims.

What is claimed is:

1. A method of making an embossed card comprising:
(a) providing a stack which includes a substrate, a first polymeric layer formed on the substrate, a foam layer formed on the first polymeric layer, a non-woven fabric layer formed on the foam layer, and a second polymeric layer formed on the non-woven fabric layer;
(b) providing a printed pattern on the second polymeric layer;
(c) providing a transparent film on the printed pattern so as to form a multilayer structure; and
(d) embossing the multilayer structure so as to obtain the embossed card.

2. The method of claim 1, wherein the substrate is made of polystyrene.

3. The method of claim 1, wherein each of the first and second polymeric layers includes ethylene vinyl acetate copolymer.

4. The method of claim 1, wherein the foam layer is made of a material selected from the group consisting of ethylene vinyl acetate copolymer, polyvinyl chloride, polyethylene terephthalate, thermoplastic polyurethane, and combinations thereof.

5. The method of claim 1, wherein the printed pattern is formed from ink.

6. The method of claim 1, wherein the transparent film is made of biaxially oriented polypropylene.

7. The method of claim 1, further comprising the step of electroplating to attach an electroplated film to the second polymeric layer prior to step (b), wherein the printed pattern is provided on the electroplated film.

8. The method of claim 1, further comprising attaching a sticker to the substrate opposite to the first polymeric layer.

9. The method of claim 1, further comprising attaching a magnetic sheet to the substrate opposite to the first polymeric layer.

10. The method of claim 1, wherein the embossing in step (d) is conducted by using a high frequency embossing machine.

11. An embossed card comprising:
an embossed multilayer structure including
a substrate;
a first polymeric layer formed on said substrate;
a foam layer formed on said first polymeric layer;
a non-woven fabric layer formed on said foam layer;
a second polymeric layer formed on said non-woven fabric layer;
a printed pattern disposed on said second polymeric layer; and
a transparent film covering said printed pattern.

12. The embossed card of claim 11, wherein said substrate is made of polystyrene.

13. The embossed card of claim 11, wherein each of said first and second polymeric layers includes ethylene vinyl acetate copolymer.

14. The embossed card of claim 11, wherein said foam layer is made of material selected from the group consisting of ethylene vinyl acetate copolymer, polyvinyl chloride, polyethylene terephthalate, thermoplastic polyurethane, and combinations thereof.

15. The embossed card of claim 11, wherein said transparent film is made of biaxially oriented polypropylene.

16. The embossed card of claim 11, further comprising an electroplated film sandwiched between said second polymeric layer and said transparent layer, and having the printed pattern.

17. The embossed card of claim 11, further comprising a sticker attached to said substrate opposite to said first polymeric layer.

18. The embossed card of claim 11, further comprising a magnetic sheet attached to said substrate opposite to said first polymeric layer.

19. The embossed card of claim 11, wherein said foam layer has a thickness of 2 mm.

20. The embossed card of claim 11, wherein said first polymeric layer has a thickness of 0.4 mm, and said second polymeric layer has a thickness of 0.1 mm.
